(19) United States
(12) Patent Application Publication
(10) Pub. No.: US 2014/0072753 A1
(43) Pub. Date: Mar. 13, 2014

(54) PROCESS FOR PRODUCING SANDWICH ELEMENTS

(71) Applicant: BASF SE, Ludwigshafen (DE)

(72) Inventors: Frank Prissok, Lemfoerde (DE); Yingchun He, Lemfoerde (DE); Joerg Poeltl, Lemfoerde (DE); Daniel Freidank, Shanghai (CN); Christophe Hebette, Bremen (DE)

(73) Assignee: BASF SE, Ludwigshafen (DE)

(21) Appl. No.: 14/025,078

(22) Filed: Sep. 12, 2013

Related U.S. Application Data
(60) Provisional application No. 61/699,902, filed on Sep. 12, 2012.

(51) Int. Cl. B29D 99/00; B32B 3/04

(52) U.S. Cl. CPC B29D 99/0021; B32B 3/04
USPC 428/71; 264/46.5

(57) ABSTRACT

The present invention relates to processes for producing sandwich elements, where the sandwich elements comprise a rigid polyurethane foam as core foam surrounded entirely or to some extent by a plastics resin comprising reinforcing-agent layers, by producing the rigid polyurethane foam on the reinforcing-agent layers and then saturating the reinforcing-agent layers in a liquid resin and hardening the resin. The present invention further relates to sandwich elements that can be produced by a process of the invention, and also to the use of these sandwich elements as wind-turbine blade, aircraft wing, wind-turbine nacelle, boat-hull, or housing for vehicles.

The present invention relates to processes for producing sandwich elements, where the sandwich elements comprise a rigid polyurethane foam as core foam surrounded entirely or to some extent by a plastics resin comprising reinforcing-agent layers, by producing the rigid polyurethane foam on the reinforcing-agent layers and then saturating the reinforcing-agent layers in a liquid resin and hardening the resin. The present invention further relates to sandwich elements that can be produced by a process of the invention, and also to the use of these sandwich elements as wind-turbine blade, aircraft wing, wind-turbine nacelle, boat hull, or housing for vehicles.

In very recent times, large-surface-area components made of metal are increasingly being replaced by components based on fiber-reinforced plastic, since these have markedly lower weight than metal components, together with high mechanical stability. A great advantage of the components made of plastic is that advantages of different plastics materials, for example the low weight of plastics foams, can easily be combined with the high stability of solid, fiber-reinforced plastics. Sandwich components of this type are by way of example used as aircraft wings, boat hulls, or wind-turbine rotor blades.

Because utilization of wind power is increasingly intensive, and because of the requirement to increase the performance of wind turbines, the number and size of rotors required is constantly increasing. In particular under storm conditions, these rotors have to withstand extreme loads. Rotor materials that have proven particularly suitable are laminates made of a rigid foam as core material and of a glassfiber-reinforced resin material as external layer. Reactive resins used here are mainly epoxy resins or polyester resins. Sandwich materials of this type and production thereof are described by way of example in WO 2012072687.

An essential factor here in particular for wind-turbine blades is when these are subjected to severe loads they are resilient and can bend to a certain extent. The same applies to aircraft wings. At the same time, the reinforcing foams are intended to be able to withstand the shear forces arising as a result of the bending.

These sandwich structures are usually in essence constructed manually, by laying, and fixing, small prefabricated pieces of the core foams manually on the laid glass scrims. The glassfiber mats are then saturated in a resin, which is then hardened. This type of process is also described by way of example in WO 2012072687. Since the prefabricated parts cannot be ideally adapted to the geometry of, for example, a wind-turbine blade, the resin-injection process produces resin accumulations in the foam core and varying thicknesses in the resin layer, which can lead to defects and materials failure in operation. Furthermore, this process is very complicated and time-consuming.

It was an object of the present invention to provide an efficient, time-saving process for producing large-surface-area sandwich elements, where sandwich elements are obtained with high stability and reduced susceptibility to defects.

The object of the invention is achieved via a process for producing sandwich elements, where the sandwich elements comprise a rigid polyurethane foam as core foam surrounded entirely or to some extent by a plastics resin comprising reinforcing-agent layers, by producing the rigid polyurethane foam on the reinforcing-agent layers and then saturating the reinforcing-agent layers in a liquid resin and hardening the resin.

Sandwich elements of the invention here comprise a rigid polyurethane foam as core material. The density-independent compressive strength of this foam in accordance with DIN 53421/DIN EN ISO 604 is preferably greater than 5.7*10⁻⁴ MPa (L/g)^{1.6}, while its density-independent modulus of elasticity in compression is preferably greater than 1.0*10⁻² MPa (L/g)^{1.7}, and its density-independent tensile strength in accordance with DIN 53292/DIN EN ISO 527-1 is preferably greater than 5.7*10⁻⁴ MPa (L/g)^{1.6}, and its density-independent tensile modulus of elasticity is preferably greater than 1.2*10⁻² MPa (L/g)^{1.7}, particularly preferably 2.0*10⁻² MPa (L/g)^{1.7}, its density-independent flexural strength in accordance with DIN 53423 is preferably greater than 1.0*10⁻³ MPa (L/g)^{1.6}, particularly preferably 1.30*10⁻³ MPa (L/g)^{1.6}, and its density-independent flexural modulus of elasticity is preferably greater than 8.8*10⁻³ MPa (L/g)^{1.7}. The density-independent shear strength of the reinforced rigid polyurethane foam of the invention is moreover preferably greater than 2.0*10⁻⁴ MPa (L/g)^{1.6}, and particularly preferably 4.0*10⁻⁴ MPa (L/g)^{1.6}. The density-independent compressive strength was calculated on the basis of compressive strength * (density)^{-1.6} , and the density-independent modulus of elasticity in compression was calculated on the basis of modulus of elasticity in compression * (density)^{-1.7}.

For a rigid polyurethane foam of the invention with a foam density of 100 g/L, this means a compressive strength which is preferably at least 0.9 MPa, particularly preferably at least 1.2 MPa, and a modulus of elasticity in compression which is preferably at least 25 MPa, particularly preferably at least 40 MPa, a tensile strength which is preferably at least 0.9 MPa, and a tensile modulus of elasticity which is preferably at least 30.1 MPa, particularly preferably at least 50 MPa, a flexural strength which is preferably at least 1.58 MPa, particularly preferably at least 2.05 MPa, and a flexural modulus of elasticity which is preferably at least 22 MPa. The density of the reinforced rigid polyurethane foam used in the invention here is from greater than 40 g/L to 400 g/L, preferably from 70 g/L to 250 g/L, particularly preferably from 100 g/L to 220 g/L.

It is particularly preferable that the rigid polyurethane foam is a predominantly closed-cell rigid polyurethane foam. The proportion of closed cells in the rigid polyurethane foam of the invention in accordance with DIN ISO 4590 is preferably at least 60% here, particularly preferably at least 70%, and in particular at least 90%. Alongside the closed cells, open cells are present, and this means that, for a closed-cell factor of 70%, the open-cell factor is 30%.

In a preferred embodiment, the rigid polyurethane foam of the invention comprises reinforcing agent, for example hollow glass microbeads, glass fibers, aramid fibers, carbon fibers, or fibers made of plastic. It is also possible that the reinforcing materials are composed of a combination of said materials. It is preferable that the rigid polyurethane foams comprise reinforcing agent in the form of laid scrims, woven fabrics, or knitted fabrics based on abovementioned fibers.

Materials in particular used are mats made of fibers such as glass fibers, aramid fibers, carbon fibers, or fibers made of plastic. In another preferred variant, the polyurethane foam of the invention comprises no reinforcing agents.

The proportion of the reinforcing agent is preferably from 1 to 40 per cent by weight, in particular from 2 to 20 per cent by weight, based on the total weight of the rigid polyurethane foam inclusive of reinforcing agents.

It is preferable that the rigid polyurethane foam is obtained via mixing of (a) polyisocyanates with (b) compounds having groups reactive toward isocyanates (c) blowing agent, comprising water, and optionally (d) catalyst and (e) further additives, to give a reaction mixture and hardening of the reaction mixture to give the rigid polyurethane foam. Rigid polyurethane foams of this type, and a process for producing these, are known and described by way of example in

The plastics resin comprising reinforcing agent surrounds the rigid polyurethane foam completely or to some extent here. It is preferable that the plastics resin comprising reinforcing agent surrounds at least 50% of the surface of the polyurethane foam, particularly from 75 to 100% of the surface, and in particular from 95 to 100% of the surface. Reinforcing agents that can be used here are fibrous reinforcing agents which have been bonded to one another in layers, for example by linkage. In one preferred embodiment, the reinforcing-agent layers are composed of laid scrims, of woven fabrics, or of knitted fabrics, based on glass fibers, aramid fibers, carbon fibers, or fibers made of plastic. Reinforcing-agent layers of this type are known and available commercially. The reinforcing agents are in particular glassfiber mats.

Plastics resin used preferably comprises resins based on epoxides, on polyurethanes, on polyesters, on polyamides, or on polyisocyanurates. Resins of this type are known, and the starting materials for producing said resins are available commercially.

The rigid polyurethane foam here is produced on the reinforcing-agent layers by applying the polyurethane reaction mixture for producing the polyurethane foam on the reinforcing-agent layers and hardening the reaction mixture to give the polyurethane foam.

The reinforcing-agent layers above and, respectively, below the rigid polyurethane foam are then saturated with a liquid resin. Liquid resin used here preferably comprises mixtures of the starting materials for epoxy-resin production, for polyester-resin production, for polyurethane-resin production, for polyamide-resin production, or for polyisocyanurate-resin production. These liquid resins are well known and are available commercially (examples being Baxxores, Baxxodur, or Elastolit Harze from BASF). Once the fibers have been saturated, the liquid resins are cured by conventional processes, for example by spontaneous reaction, heating, or irradiation. In many instances the curing of the liquid resin results simply from the mixing of the starting compounds, for example a resin component with a hardener component.

In a preferred method of producing the sandwich elements of the invention, (i) at least two reinforcing-agent layers are inserted into a mold, (ii) a polyurethane reaction mixture for producing a rigid foam is applied to the reinforcing-agent layers, where at least one of the reinforcing-agent layers is impermeable to the polyurethane reaction mixture for producing a rigid foam and the impermeable reinforcing-agent layers are not the layer facing toward the mold, (iii) the polyurethane reaction mixture for producing a rigid polyurethane foam is permitted to complete its reaction to give the rigid polyurethane foam, (iv) the reinforcing-agent layers not saturated by polyurethane are evacuated, (v) liquid resin is permitted to penetrate into the evacuated reinforcing-agent layers, the liquid resin is hardened, and (vi) the resultant sandwich element is demolded.

Conventional molds can be used here, examples being molds made of aluminum, which are preferably heatable. It is preferable that large molds are involved with a mold surface area that is preferably at least 1 m², with preference at least 5 m², and in particular at least 10 m². There is no upper limit on the area of the mold, but the areas of the molds are preferably smaller than 400 m². The mold can involve an open “half mold” which molds only a portion of the sandwich element, or a sealable “covered mold”, for example a mold with lower mold part and sealable mold cover.

It is preferable that at least two reinforcing-agent layers are inserted into the mold, preferably from 2 to 10, particularly preferably from 2 to 6, and in particular from 3 to 5 reinforcing-agent layers. The reinforcing-agent layers described above can be used here. Prior to the insertion of the reinforcing-agent layers, a conventional mold-release agent can be applied to the mold surface. As an alternative, a conventional peel ply can be inserted which prevents adhesion of the finished sandwich element to the mold surface.

The reinforcing-agent layers are arranged on top of one another in layers. These respectively cover the entire surface of the mold here, inclusive of mold cover if present, optionally with the exception of attachment locations or marginal locations. If more than two reinforcing-agent layers are inserted into the mold, at least two of the inserted reinforcing-agent layers cover the entire surface of the mold, while further reinforcing-agent layers can also cover only portions of the mold. It is therefore possible by way of example to reinforce the sandwich element of the invention specifically at particularly stressed regions. The reinforcing-agent layers can have been secured on the mold, for example via application of vacuum.

It is preferable that one of the reinforcing-agent layers is impermeable to the reaction mixture for producing the rigid polyurethane foam at the juncture of application to the reinforcing-agent layers. This impermeable reinforcing-agent layer is not the reinforcing-agent layer facing toward the mold, and it is intended to avoid a situation where all of the reinforcing-agent layers become completely wetted simply by virtue of the application of the polyurethane reaction mixture for producing the polyurethane foam, thus rendering subsequent saturation with the liquid resin impossible. A reinforcing-agent layer impermeable to the reaction mixture for producing the rigid polyurethane foam at the juncture of application to the reinforcing-agent layers is preferably a reinforcing-agent layer which is indeed wetted by the reaction mixture, where the reaction mixture does not pass through the reinforcing-agent layer in droplet form when applied to said layer. For the purposes of the invention, the expression reaction mixture for producing the rigid polyurethane foam means the mixture of components (a) to (e) at reaction conversions smaller than 90%, based on the isocyanate groups.

The reinforcing-agent layer impermeable to the polyurethane reaction mixture for producing the rigid polyurethane foam can by way of example become impermeable to the reaction mixture by virtue of a bonded structure with particularly narrow mesh. In another possibility, the reaction mixture is not applied to the reinforcing-agent layers until the viscosity of the reaction mixture has already risen to an extent that prevents it from penetrating the glassfiber mat. As an alternative, the impermeable reinforcing-agent layer can also be sealed via application of a sealant. Sealant used can by way of example comprise a liquid resin which is applied to the reinforcing-agent layer and is then hardened. The amounts of the liquid resin applied to the reinforcing-agent layer are preferably restricted to amounts such that only said layer is wetted. This can be achieved by way of example by saturation or spray-application. It is preferable that the liquid resin is spray-applied to the reinforcing-agent layer after this has been inserted into the mold. Any of the liquid resins described above can by way of example be used here.

The resin system used to seal the reinforcing-agent layer preferably adheres very well on the rigid polyurethane foam. It is preferable to use a polyurethane resin as sealant, for dependable provision of adhesion. It is particularly preferable to use, as sealant, a polyurethane resin which is obtained by using the isocyanate and the polyol that are also used for producing the reaction mixture for producing the rigid polyurethane foam. A preferred liquid polyurethane resin can moreover by way of example, in order to increase viscosity, comprise agents which have thixotropic effect and which are conventionally used in polyurethane chemistry, and/or catalysts for adjusting the reaction rate. There is no restriction on the amount of the resin system applied to the reinforcing-agent layer for sealing the same, but the amount is preferably just sufficient to seal the reinforcing-agent layer with respect to the reaction mixture for the rigid polyurethane foam. By way of example, the layer thickness of the resin system applied to the reinforcing agent is from 0.1 to 5 mm, preferably from 0.4 to 2 mm, and in particular from 0.6 to 1.2 mm. The expression layer thickness here means the thickness of a layer that would be obtained on an impermeable, flat area.

In the direction starting from the mold surface, the reinforcing-agent layer impermeable to the reaction mixture for producing the rigid polyurethane foam can be followed by further reinforcing-agent layers which are permeable to the reaction mixture for producing the rigid polyurethane foam. If said reaction mixture is then applied to the reinforcing-agent layers, it saturates all of the reinforcing-agent layers except the reinforcing-agent layer impermeable to said reaction mixture. During the subsequent foaming of the reaction mixture to give the rigid polyurethane foam, the saturated reinforcing-agent layers are moved concomitantly by the expanding foam in such a way that they are present in distributed form in the finished rigid polyurethane foam and reinforce the interior of same. If covered molds are used, it is preferable that the reinforcing-agent layers for the rigid polyurethane foam are inserted only within the lower mold part.

The application of the rigid polyurethane foam to the reinforcing-agent layers can be achieved by conventional means, for example casting or spraying. The reaction mixture is then permitted to complete its reaction to give the rigid polyurethane foam. This can take place in the open half mold or else in the closed covered mold. The completion of the reaction can optionally be accelerated by heating.

If the open half mold is used, it can be necessary to use downstream operations, for example polishing, on the resultant rigid polyurethane foam surface which has not been predetermined by the mold surface and by the reinforcing-agent layers inserted. This can be achieved by way of example by using a manual milling machine or a programmable CNC milling machine. It is preferable that a further from 1 to 10, preferably from 2 to 6, and in particular from 3 to 5, reinforcing-agent layers are then applied to the resultant rigid polyurethane foam surface not predetermined by the mold.

The saturation and hardening of the remaining reinforcement layers is preferably achieved by what is known as the vacuum infusion process. This process is well-known. The reinforcing-agent layers not yet wetted by polyurethane are evacuated. Liquid resin is then permitted to penetrate into the evacuated reinforcing agents, and this resin is hardened. In order to improve the distribution of the liquid resin within the reinforcing-agent layers, a membrane conventionally used in the vacuum infusion process, for example a flow-control mesh, can be used to improve the flow rate. The mold can be sealed by means of a vacuum-tight foil. It is also possible to use known processes other than the vacuum infusion process, where these bring about saturation of the remaining reinforcing-agent layers.

It is preferable that the sandwich elements of the invention are produced in a covered mold. The mold cover here is closed after the application of the reaction mixture for producing the rigid polyurethane foam. The cavity defined in the mold is filled by the foaming reaction mixture. The amount of the polyurethane reaction mixture here is preferably calculated in such a way as to provide reliable complete filling of the mold. Once the rigid polyurethane foam has hardened, the mold is preferably opened, and the means required for the vacuum infusion of the remaining reinforcing-agent layers are applied. These can comprise a membrane to assist flow and a vacuum foil. The remaining reinforcing-agent layers are then saturated with the liquid resin, and the resin is hardened. Finally, the finished sandwich element can be demolded, and any peel plies present can be removed. For the purposes of the invention, reinforcing-agent layers are composed of fibrous reinforcing agents which have been bonded to one another in layers, for example via linkage. In one preferred embodiment, the reinforcing-agent layers are composed of laid scrims, of woven fabrics, or of knitted fabrics, based on glass fibers, aramid fibers, carbon fibers, or fibers made of plastic. Reinforcing-agent layers of this type are known and are available commercially. In particular, glassfiber mats are used.

The process of the invention is particularly suitable for producing large sandwich elements. The volume of the sandwich elements of the invention is preferably at least 0.1 m³, particularly preferably at least 0.5 m³, and in particular at least 1 m³.

The present invention also provides a sandwich element that can be produced by a process of the invention. This type of sandwich element can by way of example be used as wind-turbine blade, aircraft wing, wind-turbine nacelle, boat hull, or housing for vehicles. Sandwich elements of the invention have low weight, and excellent mechanical strength, and are easy to manufacture. In particular, the occurrence of defects which can cause failure of the sandwich element under high load is markedly reduced.

Examples are used Below to Illustrate the Invention:

Examples of Rigid Polyurethane Foams of the Invention

TABLE 1

| | 1 | 2 | 3 | 4 | 5 | 6 |
|---|---|---|---|---|---|---|
| Polyether 1 | 31 | 31 | 31 | 40 | | |
| Polyether 2 | | | | 25 | | |
| Polyether 3 | | | | | 28 | 28 |
| Polyether 4 | | | | | 20 | 20 |
| Polyester 1 | 56 | 28 | 28 | 25 | 37 | 17 |
| Chain extender 1 | 10 | 10 | 10 | 10 | 12 | 12 |
| Chain extender 2 | | 28 | 28 | | | |
| Aromatic diol | | | | | | 20 |
| Glycerol | 3 | 3 | 3 | | | |
| Water | 1.4 | 1.45 | 1.45 | 1.0 | 2.0 | 2.0 |
| Catalyst 1 | 0.11 | 0.07 | 0.07 | 0.08 | | |
| Stabilizer 1 | 2.0 | 2.0 | 2.0 | 1.5 | 1.0 | 1.0 |
| Isocyanate 1 | 166 | 183 | 183 | 126 | | |
| Isocyanate 2 | | | | | 142 | 152 |
| Layers of glassfiber mats in foam | | | 7 | | | |
| Hollow glass beads | | | | | 17 | 8.2 |
| Foam density in g/L | 100 | 100 | 100 | 100 | 100 | 100 |
| Compressive strength in MPa | 1.03 | 0.94 | 1.24 | 0.91 | 1.42 | 1.39 |
| Modulus of elasticity in | 27.7 | 26.6 | 48.2 | 24.8 | n.d | n.d |
| compression in MPa | | | | | | |
| Tensile strength in MPa | 1.28 | 1.22 | 1.39 | n.d. | 1.11 | 1.16 |
| Tensile modulus of elasticity in | 41.3 | 36.5 | 99.3 | n.d. | n.d. | n.d. |
| MPa | | | | | | |
| 3-point flexural strength in MPa | n.d. | 1.78 | 2.85 | 1.62 | 2.03 | 2.11 |
| 3-point flexural modulus of | n.d. | 23.8 | 47.3 | n.d. | n.d. | n.d. |
| elasticity in MPa | | | | | | |
| Shear strength in MPa | 1.02 | 0.94 | 0.90 | 0.83 | n.d. | n.d. |

The following starting materials were used here:

Polyether 1: sucrose-based, Fn=4.5, number-average molar mass=515 g/mol, viscosity=8000 mPa*s at 25° C.

Polyether 2: polypropylene glycol, Fn=2, number-average molar mass=1100 g/mol, viscosity=150 MPa*s at 25° C.

Polyether 3: ethylenediamine-based, Fn=3.9, number-average molar mass=470 g/mol, viscosity=4975 MPa*s at 25° C.

Polyether 4: ethylenediamine-based, Fn=4.0, number-average molar mass=300 g/mol

Polyester 1: phthalic-anhydride/diethylene-glycol-based, Fn=2, number-average molar mass=360 g/mol

Chain extender 1: propylene-glycol-based, Fn=2, molar mass=134 g/mol

Chain extender 2: propylene-glycol-based, Fn=2, MM=190 g/mol

Aromatic diol: bisphenol-A-started polyether polyol based on propylene oxide, Fn=2, number-average molar mass 400 g/mol

Catalyst 1: tertiary aliphatic amine

Stabilizer 1: silicone-containing stabilizer for polyurethane foams

Isocyanate 1: polymeric diphenylmethane diisocyanate (PMDI), viscosity 200 mPa*s at 25° C.

Isocyanate 2: polymeric-diphenylmethane-diisocyanate-(PMDI)-based prepolymer, viscosity 250 mPa*s at 25° C.

Glassfiber mats: continuous strand mats made of glass fibers, Unifilo® U809-450 from Owens

Corning Vetrotex for foaming into PU systems

Hollow glass beads: iM30K hollow glass beads from 3M, with density 600 g/L and average diameter 15 μm

Production of the Rigid Polyurethane Foams for Testing

To produce the rigid foam of the invention, the polyols used as in table 1 were stirred with catalyst, stabilizer, and blowing agents, and then mixed with the isocyanate and optionally the hollow glass beads, and the reaction mixture was poured into a box with a basal area of 225 mm×225 mm, where it was foamed. To produce the fiber-reinforced rigid foams, the reaction mixture was charged to the same box, which now however comprised a plurality of layers of glassfiber mats. The reaction mixture penetrated into the mats, which are intended to serve as foam reinforcement, and the mats swelled with the foam rising within the box and distributed themselves homogeneously over the entire height of the foam. The blowing agent was used to adjust the foam to a constant envelope density of 100 g/L.

As can be seen from table 1, the formulations of the invention give rigid polyurethane foams having a particularly high level of mechanical properties, either with or without reinforcing agent in the foam.

Production of a Sandwich Element

Variant 1: open mold

A layer of peel ply membrane and 6 layers of laid glass scrim suitable for the vacuum infusion process are inserted into an open mold for the vacuum infusion process measuring: 2450×1800×60 mm, with a volume of 264.6 L, and an area of 4.41 m².

A thin application of a PU sealing system composed of

107 parts of polymeric diphenylmethane diisocyanate, Fn=2.8, number-average molar mass=362 g/mol,

48.9 parts of a sucrose-based polyetherol, Fn=3.9, number-average molar mass=540 g/mol,

22.5 parts of a propylene-glycol-based polyetherol, Fn=3, number-average molar mass=420 g/mol,

10 parts of dipropylene glycol,

15 parts of tri-2-chloropropyl phosphate,

0.8 part of a polysiloxane, and

2.5 parts of triethanolamine in 1,4-butanediol (25%) is sprayed onto the uppermost glass-mat layer, and hardens.

Foam system No. 2 is applied to the sealed glass-mat layer, reacts, foams, and hardens, and completely covers the glass-mat layer. The amount of the system applied and the target density give the desired layer thickness of the foam. Uneven areas and excessive layer thickness of the foam at individual locations are removed mechanically with a milling machine, thus giving a uniform layer thickness of 6 cm of foam. The flow channels for the resin infusion process are prepared.

The following are then superposed: 6 layers of laid glass scrim, 2 layers of peel ply, a flow-control mesh, a VAP membrane (vacuum assisted process), and another flow-control mesh, and finally the vacuum foil is secured.

The following materials were used for the vacuum infusion structure:

Laid glass scrim: Biax OCV laid glass scrim, weight per unit area 811 g/m² (Saertex)

Vacuum foil: VACFILM450V260 (Vacfilm450V-Tub-0.05 mmX1, 50M×300LM) (FlugzeugUnion Süd)

Flow-control mesh: 180 g/m² vacuum mesh—item No.: 390184-5; 10 m roll (20 m²) (R&G Faserverbundwerkstoffe)

Peel ply: peel ply, weight per unit area 95 g/m² (R&G Faserverbundwerkstoffe)

VAP membrane: VAP membrane (Saertex)

Infusion and vacuum hoses are secured on the final layer.

The vacuum infusion of the laid glass scrims is carried out with an epoxy resin system from BASF SE.

Resin: Baxxores ER 5400

Hardener: Baxxodur EC 5430

Mixing ratio: 100 : 30 parts by weight

In order to accelerate hardening, the mold is heated to 70° C. after infusion.

The finished sandwich element is removed, and the auxiliary foils and auxiliary fabrics are removed with the peel plies.

A specimen of a foam sample taken exhibits the same properties as the foamed slab sample.

Variant 1.1

Fiber-Reinforced Foam Core

Foam system No. 3 is used instead of foam system No. 2.

After spray-application of the barrier layer, 7 layers of Unifilo® U809-450 reinforcing mats are inserted loosely into the mold and fixed at the margin. After introduction of PU system No. 3, the mats are saturated by the liquid PU system. After foaming of the system they are present in exfoliated form within the foam core. Further operations take place as above.

Variant 1.2

Instead of the 6 layers of laid glass scrim in variant 1, only 5 layers of laid glass scrim are inserted, followed by one layer of a glassfiber fabric woven in such a way as to prevent penetration by the foam system. Application of the PU sealing system is omitted. The procedure continues as in variant 1.

Variant 2: Closed Mold

The procedure is as in variant 1.2. The mold from variant 1 is equipped with a tightly closing cover and vacuum ducts. The amount of the foam system to be introduced is calculated in such a way as to give a compaction factor of 1.1 in the mold (factor of 1.1 applied to amount charged). The resultant foam density in the mold is 110 g/L, if the free-foamed density of the system is 100 g/L. After introduction of the foam system, the mold cover is closed, and after hardening of the system and opening of the cover the procedure corresponds to variant 1.

Variant 2.1

The procedure is as in variant 2, and the following are superposed and secured here on the cover: 6 layers of laid glass scrim, 2 layers of peel ply, a flow-control mesh, a VAP membrane (vacuum assisted process), and another flow-control mesh, and the vacuum foil. The respective externally located laid glass scrim layer is a glass fabric impermeable to the PU system. After the reaction of the PU foam system, the system for securing the outer layers is removed from the mold cover, the mold cover is opened, and the outer layers inclusive of the vacuum foil as final layer remain in the mold on the foam core. Vacuum infusion is carried out as in variant 1, and then the component is demolded.

1. A process for producing sandwich elements, where the sandwich elements comprise a rigid polyurethane foam as core foam surrounded entirely or to some extent by a plastics resin comprising reinforcing-agent layers,
by producing the rigid polyurethane foam on the reinforcing-agent layers and
then saturating the reinforcing-agent layers in a liquid resin and hardening the resin.

2. The process for producing sandwich elements according to claim 1 where
i. at least two reinforcing-agent layers are inserted into a mold,
ii. a polyurethane reaction mixture for producing a rigid foam is applied to the reinforcing-agent layers, where at least one of the reinforcing-agent layers is impermeable to the polyurethane reaction mixture for producing a rigid foam and the impermeable reinforcing-agent layers are not the layer facing toward the mold,
iii. the polyurethane reaction mixture for producing a rigid polyurethane foam is permitted to complete its reaction to give the rigid polyurethane foam,
iv. the reinforcing-agent layers not saturated by polyurethane are evacuated,
v. liquid resin is permitted to penetrate within the evacuated reinforcing-agent layers, the liquid resin is hardened, and
vi. the resultant sandwich element is demolded.

3. The process according to claim 1 or 2, wherein the reinforcing-agent layer impermeable to the polyurethane reaction mixture has been sealed by applying a polyurethane reaction mixture and completing the reaction of same.

4. The process according to any of claims 1 to 3, wherein the liquid resin is a polyurethane reaction mixture, an epoxy resin reaction mixture, a polyester resin reaction mixture, a polyamide resin reaction mixture, or polyisocyanurate resin reaction mixture.

5. The process according to any of claims 1 to 4, wherein the rigid polyurethane foam has a closed-cell factor of at least 60% of the cells.

6. The process according to any of claims 1 to 6, wherein the polyurethane foam comprises reinforcing agent.

7. The process according to any of claims 1 to 7, wherein the polyurethane foam is obtained via mixing of
a) polyisocyanates with
b) compounds having groups reactive toward isocyanates
c) blowing agent, comprising water, and optionally
d) catalyst, and
e) further additives, to give a reaction mixture, and hardening the reaction mixture.

8. The process according to any of claims 1 to 8, wherein the polyurethane reaction mixture for producing the rigid polyurethane foam is applied by pouring or spraying onto the reinforcing-agent layer that is impermeable to the reaction mixture, and also onto further reinforcing-agent layers optionally present, and its reaction to give the rigid polyurethane foam is completed.

9. The process according to claim 9, wherein the resultant rigid polyurethane foam is smoothed on the surface and further reinforcing-agent layers are superposed before, in step iv), the reinforcing-agent layers not saturated by polyurethane are evacuated.

10. The process according to any of claims 1 to 9, wherein the mold has a lower mold part and an upper mold part which, in the closed condition, form an enclosed space, and where, in step (i), at least two reinforcing-agent layers are inserted into the lower mold part and also into the upper mold part, and the mold is closed, and, in step ii), the reaction of the polyurethane reaction mixture for producing a rigid polyurethane foam is completed in the cavity between mold upper part and mold lower part to give the rigid polyurethane foam, where at least respectively one of the reinforcing-agent layers in the lower mold part and in the upper mold part is impermeable to the polyurethane reaction mixture for producing a rigid foam, and the impermeable reinforcing-agent layer is not the layer facing toward the mold.

11. The process according to any of claims 1 to 11, wherein reinforcing-agent layers are glassfiber mats.

12. The process according to any of claims 1 to 12, wherein the volume of the sandwich element is at least 0.1 m³.

13. A sandwich element obtainable by a process according to any of claims 1 to 13.

14. The use of a sandwich element according to claim 13 as wind-turbine blade, aircraft wing, wind-turbine nacelle, boat-hull, or housing for vehicles.
